(19) United States
(12) Patent Application Publication
(10) Pub. No.: US 2016/0208422 A1
(43) Pub. Date: Jul. 21, 2016

(54) Bendable Straight Knitting Needle With Ergonomic Benefit

(71) Applicant: Cyrus Tabibian, West Hills, CA (US)

(72) Inventor: Cyrus Tabibian, West Hills, CA (US)

(73) Assignee: Cyrus Tabibian, West Hills, CA (US)

(21) Appl. No.: 14/599,284

(22) Filed: Jan. 16, 2015

(51) Int. Cl. D04B 3/02; B23P 19/00

(52) U.S. Cl. CPC D04B 3/02; B23P 19/00

(57) ABSTRACT

A bendable straight knitting needle consisting of three parts (1,2,3) that provides ergonomic benefit by enabling bending of the needle during stitch/loop creation by the knitter typically done with two knitting needles, one in each hand. The addition of a bendable portion to the standard conventional straight knitting needle would allow flexible knitting motion with enhanced comfort and better ease of knitting in a tight space.

### FIELD OF INVENTION

The present invention relates to a bendable straight knitting needle, specifically a straight knitting needle made from any material. Accordingly, a method to realize this invention is also provided.

### BACKGROUND OF INVENTION

Standard straight knitting needles generally range from 10 to 16 inches, being a narrow stiff shaft that tapers at one end and has a knob at the other end to prevent stitches from slipping off Straight knitting needles are known to be made of plastic, metal, casein, or wood. These needles are used in knitting to pull loops of string through one another. Needles come in the thickness from 0.75 mm to 25 mm and are commonly marked with U.S. or U.K. sizes that correspond to the mm thickness. The long narrow stiff shaft is not bendable and can therefore result in pain, tiredness and numbness from repeated motion of writs, hands, and fingers during the formation of loops in the knitting position that must accommodate to the long straight stiff knitting shaft as well as difficulty maneuvering comfortably while knitting in confined spaces and around surrounding obstacles.

### SUMMARY OF INVENTION

The present invention relates to a bendable straight knitting needle consisting of two relatively stiff shanks (1,2) one pointed at one end and one back end with internal screw threads in positioned within the back end (1) and one end is a knob and back end with internal screw threads in position within the back end (2), wherein said shanks are connected with each other by the back ends with a bendable vinyl hollow connecting tube containing a metal coil with external metal screw attached at each end of the coil (3) comprising a joint; and said joint between the stiff shanks (1,2) and the bendable hollow connecting tube (3) consisting of an external metal screw attached to the metal coil at each end and protruding out of the tube that contains the metal coil (3) to be inserted into the back end of the shank (1,2) wherein internal screw threads are positioned.

The advantage of the bendable connection is the ability to bend the needle during formation of loops in a more comfortable manner for arm, wrist, hand, and finger movements as well as more ease of knitting movement in a confined work space.

The invention also provides a method for the manufacture of the bendable knitting needle with ergonomic benefit.

### DETAILED DESCRIPTION OF THE INVENTION

The present invention relates to a bendable straight knitting needle with ergonomic benefit, specifically, a long, thin, pointed rod from any material with a bendable addition which enables more natural, less labored movement of the arms, hands, wrists, and fingers during stitch formation compared to the prior art and is more accommodating to use when surrounding work space is limited. Also, the method of realizing this invention is relatively simple while maintaining the same functionality.

The bendable straight knitting needle with ergonomic benefit consists of two stiff shanks (1,2) pointed at one end (1) and one knob end (2) and suitably machined for attachment at the other ends (1,2).

Thus the product consists of two stiff shanks, one suitably pointed at one end for knitting and one with a knob at the base for holding knitted stitches, connected from the other ends using a bendable hollow vinyl tube containing a metal coil with attached metal external screws at each end of coil. The joint between the stiff shank and the bendable connecting tube consists of internal screw threads positioned inside the back end of each shank and a metal external screw connected to the metal coil that is contained in the hollow vinyl tubing. The bendable tubing will be the same thickness as the shank and extremely smooth enabling the individual stitches to slide over connection and tubing without impairment, and bendable for ergonomic benefit.

Another aspect of the invention is the method to realize this invention. The two stiff shanks of the knitting needle are made from plastic, metal, casein, or wood. The joint between the stiff shanks and the bendable tube is made by inserting the external screw which is attached to the metal coil that is contained in the bendable vinyl tube, into the stiff shank where internal screw threads are positioned and screwed and glued together.

In a preferred embodiment, the stiff shank is made of a plastic whereas the bendable connecting tube is made of bendable hollow vinyl, metal coiling, and attached external metal screw at each end of coil. In the back ends of shaft 1,2, internal screw threads are positioned and drilled.

In another embodiment of the invention, a method for the manufacture of the bendable knitting needle is provided. The shanks are manufactured by conventional manufacturing processes. The addition of the bendable material is the substance of the invention. The bendable material used is in the form of a vinyl hollow tubing that matches the thickness of the stiff shanks, metal coil with attached metal external screws. This bendable tube is connected to the stiff shanks using a protruding external screw at each end of bendable tube to be inserted and screwed into the threads of the internal screw threads which are positioned in the back ends of the stiff shanks

The joint itself is made by the vinyl tubing and metal parts with attached external screw, threaded to the internal screw threads within the plastic shanks The tolerances are such that they meet the requirements of the product and the joint.

The screw is manufactured and attached to the metal coil, which is contained in the clear bendable vinyl tube.

The stiff shanks are made with the back end (the end that is not pointed or knobbed) finished to a diameter suited for development of a drilled internal screw. The external metal screw that is attached to the metal coil, which is contained in the bendable vinyl tube matches the thickness of the shank and is then inserted into the back ends of the stiff shanks.

The threaded portion of the external screw is attached directly into the internal screw threads which are positioned within the shank.

Adhesive is applied to the threaded portions to ensure that it is a permanent tight lock.

The above method results in a bendable straight knitting needle, which has the ability to bend in a manner that would be of ergonomic benefit in mobility and can accommodate more readily to a confined workspace.

### DETAILED DESCRIPTION OF THE ACCOMPANYING DRAWINGS

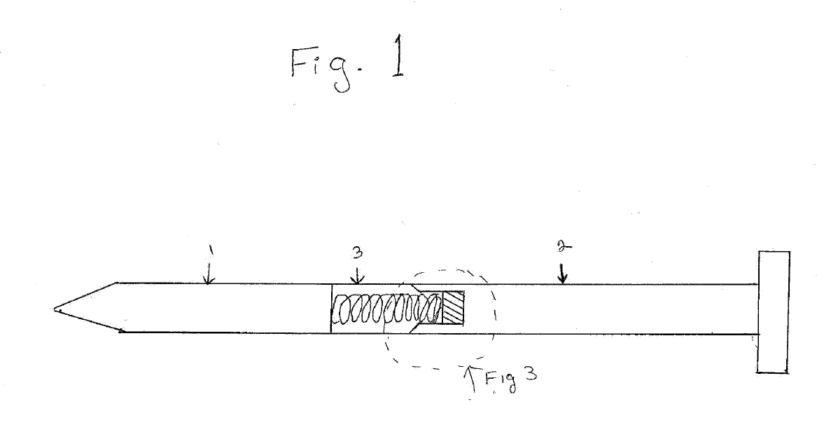

FIG. 1 illustrates a perspective schematic view of the present invention. The two relatively stiff ends of the needle are denoted by 1,2 whereas the bendable connecting tube between the two shanks is denoted by 3. The shank is made from plastic whereas the bendable connecting tube is made from vinyl. See FIG. 1.

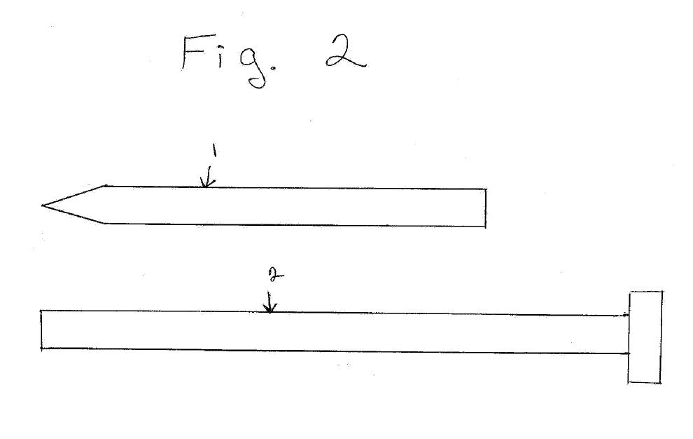

FIG. 2 illustrates one end of the needle or shank (1) which is pointed at one end and the other end forms a joint with the bendable connecting tube and one end of the knobbed shank (2) which has a knob at one end and the other end forms a joint with the bendable connecting tube. See FIG. 2.

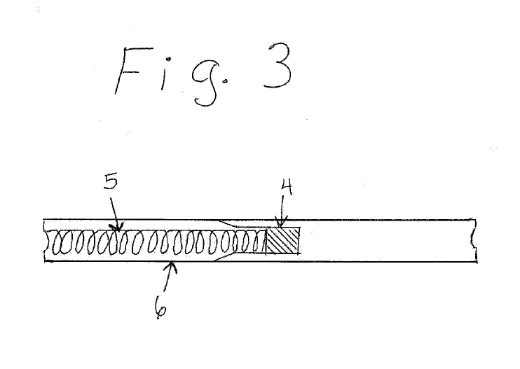

FIG. 3 illustrates the junction between the shank and the bendable connecting tube where the external screw (4) and metal coil (5) are connected, and coil contained in the vinyl tubing (6) are shown in detail. See FIG. 3

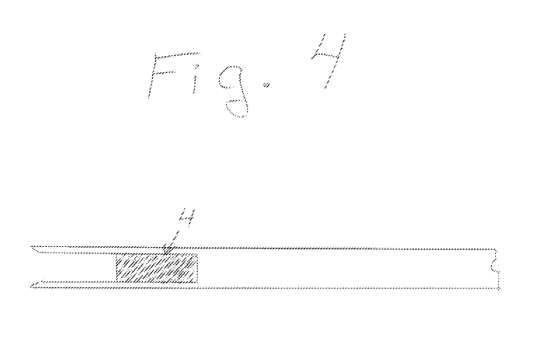

FIG. 4 illustrates positioning of the drilled internal screw threads (4) in the back end of each shank and the design of which shows an inward curvature that will insure a strong and even one-level closure when the connecting vinyl tube is attached. See FIG. 4.

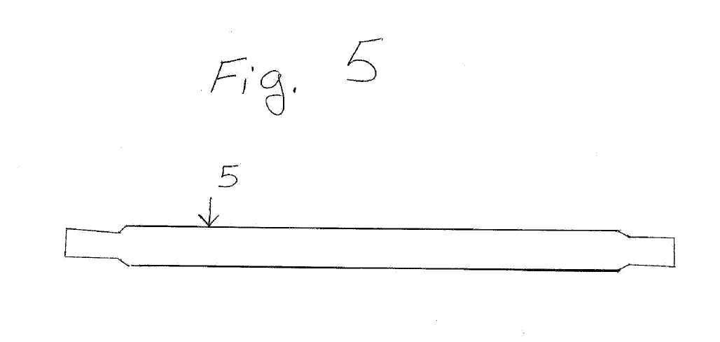

FIG. 5 illustrates the design of the bendable vinyl tubing that will connect the two stiff shafts at their back ends. A portion of the end of the vinyl tubing that contains the metal coil will also be inserted into the back end of shaft. The design shows 2 slanted edges at each end of bendable tube that will meet the opposing slanted edge of the shafts during attachment. This will insure a strong and even one-level closure when connecting. See FIG. 5.

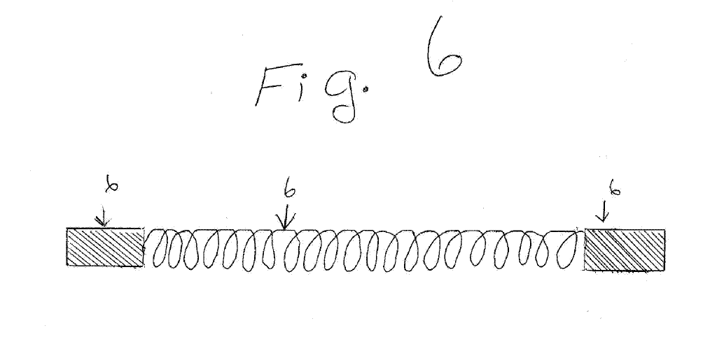

FIG. 6 illustrates the metal coil that will be contained in the vinyl tubing with the external screws attached at each end which will protrude outward from the bendable vinyl tube. See FIG. 6.

Various modifications and alterations of this invention will become apparent to those skilled in the art without departing from the scope and spirit of this invention and it should be understood that this invention is not unduly limited to the illustrative embodiment set forth herein.

The invention claimed is:

1. A bendable straight knitting needle with ergonomic benefit comprising of two relatively stiff shanks with one having a pointed end and back end and the other having a knobbed end and back end; wherein internal screw threads are positioned within back ends of shanks; a bendable connecting material being the same thickness as the needle containing a metal coil with attached external screw at each end of coil; wherein the shanks are connected by their back ends via the bendable connecting material and joint; wherein the external screw and small portion of tube and coil are inserted into the back end of each stiff shank; wherein the threaded portion of the external screw is connected to the threaded portion of the internal screw in back end of shank; with bendable portion of the needle to provide the ability to bend the needle during creation of loops resulting in more flexible movement of the wrists, pressure relief to portions of the knitter's fingers, elbows, wrists and hands, with enhanced comfort, ability to knit longer periods of time with less pain and tiring of hands, less aching from the repetitive motion inherent in knitting activity which are also experienced as well as the ability to knit more comfortably in tight spaces without the long straight stiff shafts protruding out from either side during knitting activity which can be obstructed by environmental obstacles.

2. A bendable straight knitting needle in claim 1 wherein two relatively stiff shanks, one with pointed end and back end and the other having a knobbed end and back end with internal screw threads positioned within each back end.

3. A bendable straight knitting needle in claim 1 wherein the bendable connecting material is a bendable hollow tube of the same thickness as the shank and of which contains a coil with attached external screws.

4. A bendable straight knitting needle in claim 1 wherein the stiff shanks are made from plastic, metal, casein, or wood.

5. A bendable straight knitting needle in claim 1 wherein the shank is made of plastic and the bendable hollow connecting material is made from vinyl; metal coil; external metal screw.

6. A bendable straight knitting needle in claim 1 wherein the bendable material connected between the stiff shanks that will enable more natural mobility of hands during formation of loops with less incidence of physical stressors, tiredness from repetitive movement, as well as conforming better to environmental obstacles and tight spaces during loop creation.

7. A method of producing a bendable straight knitting needle as claimed in claim 1 comprising the steps of; finishing the back end of the pointed shank and back end of the knobbed shank; wherein containing drilled internal screw threads; inserting the external screw that is attached to the each end of the metal coil and of which protrudes from the bendable hollow connecting tube that contains the coil; attaching the threaded portion of the external screw into the back end of each shaft and screwed into the internal screw threads which are positioned in each back end with the use of an adhesive.

8. A method of knitting comprising a) bendable portion of a long stiff straight knitting needle that especially during formation of loops can bend with ergonomic benefit and thus minimizing and/or alleviating many physical stressors as claimed in claim 1; b) less environmental obstructions due to tighter spaces as claimed in claim 1.
